(19) United States
(12) Patent Application Publication
(10) Pub. No.: US 2012/0237064 A1
(43) Pub. Date: Sep. 20, 2012

(54) Apparatus and Method For The Adjustment of A Hearing Instrument

(76) Inventors: Reginald Garratt, Naples, FL (US); Sean Garratt, Schaumburg, IL (US)

(21) Appl. No.: 13/051,113

(22) Filed: Mar. 18, 2011

(51) Int. Cl. H04R 25/00

(52) U.S. Cl. 381/314

(57) ABSTRACT

The patient is presented with an audio sound. The patient is also presented with a visual representation of the sound at a visual display. A response to the audio sound and the visual representation is received from the patient via a first interface and the response indicates a perception of sound from the patient. Based upon the response from the patient, a first adjustment to the base setting parameters of the hearing instrument is performed that is effective to adjust the sound. The audio sound is re-presented to the patient with the adjusted sound. Subsequently, fine-tuning commands are received from the patient via a second interface that fine-tuning commands are effective to make a fine-tuning adjustment to the hearing instrument.

### FIELD OF THE INVENTION

The field of the invention relates to hearing instruments and, more specifically, to adjustment of these hearing instruments.

### BACKGROUND OF THE INVENTION

The prevalence of hearing loss is a growing concern for many in society today. Hearing loss may result in as well as magnify the severity of a variety of physical and psychological problems. It is an unfortunate fact that many patients suffering from hearing loss are never diagnosed, let alone treated for their condition as indicated in a by various studies.

Various types of hearing instrument services are provided today. Licensed Audiologists and Hearing Instrument Specialists are required to fit the hearing aids with the patient in many if not most jurisdictions. Based upon a variety of audiometric tests, the Audiologist or Hearing Instrument Specialist orders a digital hearing instrument, which the Audiologist or Hearing Instrument Specialist adjusts to meet the specific needs of the patient.

In fitting hearing instruments to patients, the hearing instrument are not adjusted for a specific patient when shipped from the factory. As a result, they need to be adjusted when fitted to the patient. One of the problems with previous approaches is that they relied on the Audiologist or other specialist to determine whether the instrument was correctly adjusted to correct for the hearing loss characteristics indicated from the audiometric tests. Even if there was some patient involvement, this involvement was not sufficient to tune the hearing instrument to the correct settings. As a result, the patients often complained that they could not hear sounds correctly because their hearing aid had been inadequately or improperly tuned to the best ability of the audiologist or specialist. This has led to patient dissatisfaction with previous approaches.

### BRIEF DESCRIPTION OF THE DRAWINGS

FIG. 1 comprises a flowchart of one example of tuning a hearing instrument according to various embodiments of the present invention;

FIG. 2 comprises a flowchart of another example of tuning a hearing instrument according to various embodiments of the present invention;

FIG. 3 comprises a block diagram of one example of a system for adjusting a hearing instrument according to various embodiments of the present invention;

FIG. 4 comprises a block diagram of one mapping approach used, for example, with the approach of FIG. 1 according to various embodiments of the present invention;

FIG. 5 comprises a block diagram of one mapping approach used, for example, with the approach of FIG. 2 according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

As described herein, approaches are provided that allow the patient to participate in the programming tuning of their own hearing instrument in real-time and interactively. That is, the patient does not have to wait for completion of a long adjustment process which analyzes large amounts of input data. The approaches described herein allow for incremental adjustments to hearing instrument parameters to be made over time resulting in better results. Advantageously, the interactive and real-time aspects of the present approaches also allow the patient to quickly tune the hearing aid as compared to previous approaches. Consequently, patient satisfaction with the results is increased since a better result (i.e., that results in better patient hearing) is produced. The approaches described herein may be performed one ear at a time to tune for individual ear hearing loss.

In many of these embodiments, the patient is presented with a phoneme-rich audio sound or word. As used herein, the term “phoneme-rich” refers to a speech utterance, such as “k,” “ch,” and “sh,” that is used in synthetic speech systems to compose words for audio output.

The patient, after a few seconds is presented with a visual representation of the sound at a visual display (e.g., a computer screen or touch screen). The patient will see the letter or sound they did not hear clearly or was in their perception missing. A response to the missing audio sound indicated from the visual representation is received from the patient via a keyboard interface, and the response keyed in indicates a perception of the missing sound observed from the visual presentation, from the patient. Based upon the response from the patient, an algorithmic adjustment of the hearing instrument is performed that is effective to adjust to correct for the missing the sound. The audio sound is re-presented to the patient with the adjusted sound. Subsequently, fine-tuning commands are received from the patient via a second interface (that may be the same or different from the first interface) and the fine-tuning commands are effective to make a fine-tuning adjustments to the hearing instrument. Often, these fine-tuning commands make incremental adjustments in scale, scope, or magnitude to parameters of the hearing instrument than the first adjustment mentioned above.

In other aspects, after receiving each of the fine-tuning commands and making the fine-tuning adjustment to the hearing instrument indicated by each of the fine-tuning commands, the audio signal is re-presented to the patient with the fine-tuning adjustment. After successive fine-tuning commands are received from the patient, and under the supervision of the audiologist or technician, an optimum result may be obtained (i.e., a result that maximizes the hearing potential of a particular patient that uses a particular hearing instrument).

In other aspects, the visual display comprises a computer terminal. In some examples, the first interface comprises a keyboard and the second interface comprises up and down arrows from the keyboard. In some other examples, the sending of fine-tuning commands is terminated by an audiologist. In still other examples, the patient decides they need to no longer fine-tune the hearing instrument when they determine the sound is acceptable. This process is similar to that of an optician incrementally changing lenses to make a determination for visual correction.

In some other aspects, the settings of the hearing instrument must be initialized using audiogram-related approaches and supervised by an audiologist or specialist. These initial settings for the hearing instrument are determined following a physical examination of the patient's ears, then taking an audiogram and other hearing related measurements. The audiogram results are based on tones which are not heard by the patient. It should be observed that at this stage that speech is not used to determine the initial settings of the hearing instrument.

In others of these embodiments, the patient is presented with a first phoneme-rich audio sound or word. On a visual display (e.g., a computer screen), the patient is, after a few seconds, then presented with first multiple visual options (e.g., a multiple choice list of options) as to the identity of the first sound. A first response to the multiple options and sound is received from the patient via a first interface (e.g., a keyboard) and the first response indicates a first choice of the patient as to the identity of the first sound (e.g., the patient is presented with multiple choice phoneme sounds or words in the form of a list and the patient selects one of these from the list). Subsequently and based upon the response from the patient, an adjustment of the hearing instrument is performed, based on the algorithms required to correct the errors identified by the patient and the adjustment is effective to adjust the first sound. The now adjusted sound (i.e., adjusted because of the parameter adjustments to the hearing instrument) is then re-presented to the patient. These steps are repeated until the response(s) of the patient indicate an acceptable perception of the first sound. Whether the perception is acceptable may be determined, for example, by the patient correctly choosing the sound from the list of sounds presented to them.

Then, the patient is presented with a second phoneme-rich audio sound and this second phoneme-rich sound is different from the first phoneme-rich sound. On the visual display, the patient is again presented with second multiple visual options (e.g., a multiple choice list of options) as to the identity of the second sound. A second response to the multiple options and the second sound is received from the patient via the first interface and the second response indicates a second choice of the patient as to the identity of the second sound. Subsequently and based upon the second response from the patient, a second adjustment of the hearing instrument is performed and the second adjustment to the hearing instrument is effective to adjust the second sound. The second sound is re-presented to the patient and incorporates the second adjustment made by the hearing instrument. These steps are repeated until the response of the patient indicates an acceptable perception of the second sound. Whether the perception is acceptable may be determined, for example, by the patient correctly choosing the sound from the list of sounds presented to them. In other aspects, a final adjustment of the hearing instrument is performed that incorporates both the first adjustment and the second adjustment. This final adjustment attempts to balance both adjustments to obtain an optimal result for the patient.

In still others of these embodiments, a system for tuning a hearing instrument includes a speaker, a visual display, an interface, and a controller. The speaker is configured to present the patient with an audio sound or word (e.g., a phoneme rich sound or word). The visual display is configured to present the patient with a visual representation of the sound or word that has just been audibly presented to them. The interface is configured to receive a response from the patient to the audio sound and the visual representation and the response from the patient indicates a perception of the sound of the patient (i.e., what the patient thinks they heard). The controller is coupled to the speaker, the visual display, and the interface. The controller is configured to, based upon the response from the patient, send a first signal to the hearing instrument that adjusts at least one parameter of the hearing instrument and causes an adjustment of the sound. The controller is further configured to cause the adjusted audio sound to be presented to the patient at the speaker.

The controller is still further configured to subsequently receive fine-tuning commands from the patient via the interface. The fine-tuning commands are effective to cause the controller to transmit a signal to the hearing instrument that makes a fine-tuning adjustment to the hearing instrument. As mentioned, these fine-tuning commands typically make small changes in scope, range, or magnitude to parameters of the hearing instrument as compared to changes triggered by the first response. In other aspects, the controller is configured to, after receiving each of the fine-tuning commands, to make the fine-tuning adjustment to the hearing instrument indicated by each of the fine-tuning commands, and the audio signal to be re-presented at the speaker to the patient with the fine-tuning adjustment.

It will be appreciated that in many of the approaches described herein the hearing instrument may be interactively tuned by the patient and in real time. For example, the fine-tuning commands are made, the hearing instrument is re-tuned, and the sound is re-presented substantially immediately to the patient. In other words, hearing instrument is not re-programmed only once after a battery of tests are performed on the patient, but is tuned incrementally and over time. This incremental and real-time programming allows the hearing instrument to be tuned with much greater precision and with much better results than previous approaches.

The adjustments explained above will also be made with the addition of various background noises, such as the phoneme rich sound in the presence of speech and babble as well as a simulation of other backgrounds sounds such as music and environments which the patient has pre identified as those they often experience.

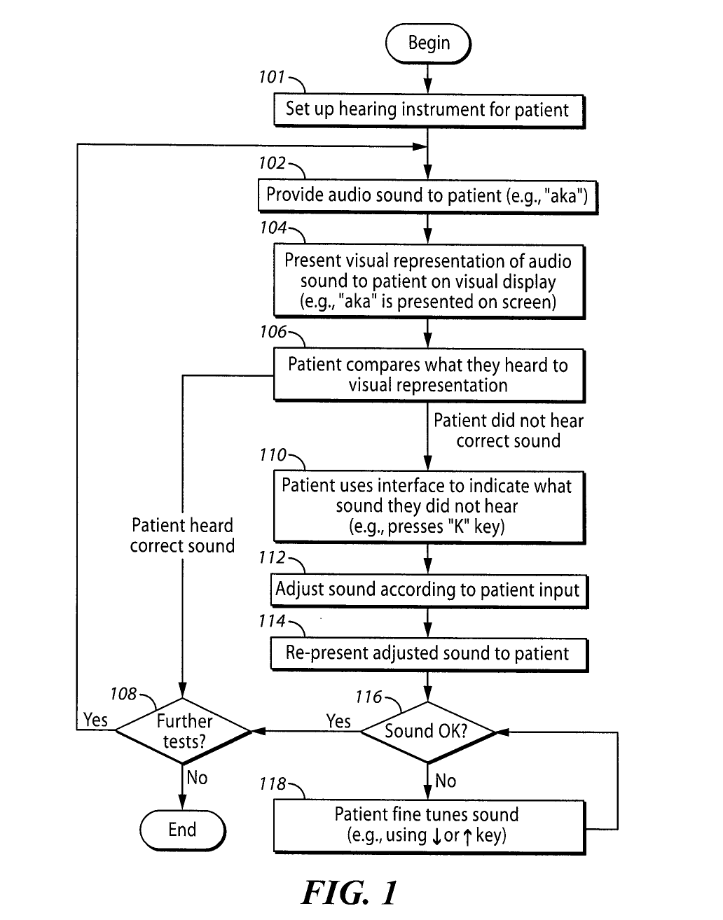

Referring now to FIG. 1, one example of an approach for tuning a hearing instrument is described. This approach may be performed one ear at a time to tune for individual ear hearing loss. At step 101, set up of the hearing instrument (e.g., a hearing aid) is performed. For example, using audio-gram related set up approaches, the initial settings for the hearing instrument are made. This may be performed, in one example, by an Audiologist.

At step 102, a sound (e.g., a phoneme-rich sound) is presented to the patient. This may be done by via a speaker. For example, the sound “aka” may be presented to the patient. In the examples herein, the sound “aka” is often used as an example. However, it will be appreciated that in some circumstance phonemic stimuli may be rotated instead of repeating the same test again and again.

At step 104, a visual representation of the sound is presented to the patient via a visual display (e.g., a screen on a computer terminal). In this example, the phrase “aka” may be presented on this screen. Information is also presented on the screen telling the patient that this sound is what the patient should be hearing (e.g., “This is the sound you should be hearing . . . ”).

At step 106, the patient compares the sound they heard (communicated via a speaker and hear using the hearing instrument) to what they should have heard (communicated to them via the visual display). If the sound they heard is the same as to what they should have heard, no adjustment of the hearing instrument is required and at step 108, it is determined if further tests are needed. If the answer at step 108 is affirmative, then execution continues at step 102 as described above. If the answer is negative, then execution ends.

If at step 106, the patient has not hear the sound that was actually presented, and then at step 110, the patient uses an interface to indicate an adjustment to the sound they did hear that would render this sound to the sound they were intended to hear. For example, the interface may be a keyboard and in one example, the patient hears “ama” instead of “aka.” Thus, the patient presses the “k” key indicating that the “k” sound is the sound that they did not hear.

At step 112, the hearing instrument is adjusted according to the response. For example, the “k” key of the keyboard may be mapped to particular parameter adjustments. These adjustments are made to the hearing instrument, which alter the sound. For instance, parameters include the frequency, intensity, gain, compression, or timing of the hearing instrument. Other examples and combinations of parameters are possible.

At step 114, the adjusted sound (adjusted since the hearing instrument has been re-tuned by adjusting one or more of its parameters) is re-presented to the patient. At step 116, the patient determines whether the sound is correct (e.g., does the sound now appear to be “aka” to the patient?). In other approaches, the audiologist may make this determination after consultation with the patient. If the answer is affirmative, then execution continues at step 108 as has been described above.

If the answer at step 116 is negative, execution continues at step 118 where the patient fine tunes the sound. This may be performed at the same or a different interface as previously used by the patient. In one example, the patient may use the up-arrow key and the down-arrow key to fine tune the patient. Fine-tuning adjusts parameters of the hearing aid (e.g., one or more of the frequency, intensity, gain, compression, or timing) in smaller increments than those made in step 112. Execution continues with step 116 as described above.

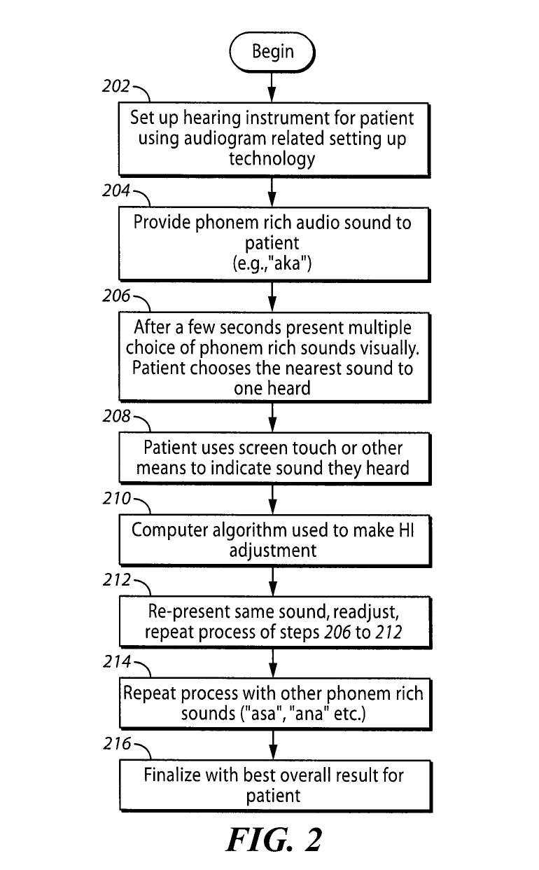

Referring now to FIG. 2, another example of another approach for tuning a hearing instrument is described. This approach may be performed one ear at a time to tune for individual ear hearing loss. At step 202, set up of the hearing instrument (e.g., a hearing aid) is performed. For example, using audio-gram related set up approaches, the initial settings for the hearing instrument are made. This may be performed, in one example, by an Audiologist.

At step 204, a sound (e.g., a phoneme-rich sound) is presented to the patient. This may be done by via a loud speaker. For example, the sound “aka” may be presented to the patient.

At step 206, after a predetermined time period (e.g., a few seconds), the patient is visually presented on the screen multiple choices as to the identity of the sound that was just presented to them. This may be in the form of a list. The patient is asked to choose one of the sounds from the list as the sound they heard. In one example, the patient may be presented with possible choices of “aka”, “ama” or “aba” and be asked to choose one of these sounds from the list.

At step 208, the patient uses an interface (e.g., keyboard, touch screen or so forth) to indicate the sound they heard. As compared to the approach of FIG. 1, it will be appreciate that in this approach, the patient is never informed of the sound they should hear.

At step 210, the hearing instrument is adjusted according to the response received from the patient. For example, if “aka” were presented to the patient, and the patient indicated that they heard “aka” no adjustment is made to parameters of the hearing instrument. If the sound “aka” was presented to the patient, and the patient indicated that they heard “ama,” a first adjustment to the hearing instrument could be made. If the “aka” were presented to the patient, and the patient indicated that they heard “aba” a second adjustment could be made. The adjustments made relate to any type or combination of operating parameter of the hearing instrument such as the frequency, intensity, gain, compression, or timing. Other examples are possible.

At step 212, the same sound (e.g., “aka”) is presented to the patient, and steps 206-210 are repeated. This occurs until it is determined that the patient has adequately heard the sound. This determination may be made by the patient, the audiologist, or both.

At step 214, the process of steps 204-212 is repeated with another phoneme rich sound (e.g., “asa”, “ana” or so forth). At step 216, the settings of the hearing instrument are finalized with a best overall result for the patient. In other words, before locking in an adjustment to the hearing instrument there will be an inter-effect of the different adjustments. The final adjustment may consider all of these individual adjustments to provide optimal adjustment to each parameter.

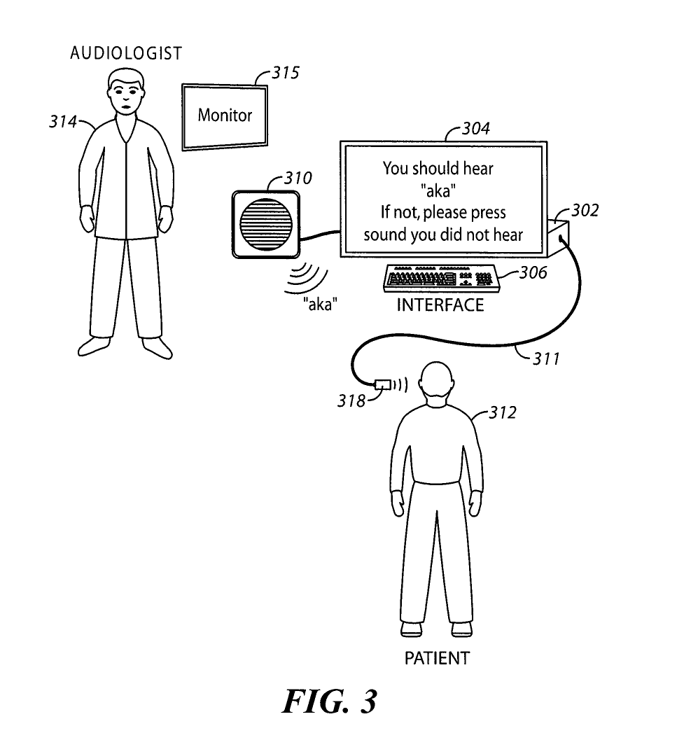

Referring now to FIG. 3, one example of a system that tunes a hearing instrument is described. The system 300 includes a controller 302, a visual display 304, a speaker 310, an interface 306, and a hearing instrument 308.

The controller 302 is any hardware/software combination that executes computer instructions stored on computer media. The visual display 304 is any type of visual display such as a computer screen. In other examples, a touch screen can be used. Other examples of visual displays are possible. The speaker 310 is any speaker device that produces audio sounds that can be heard by humans. The interface 306 is any interface by which a user communicates instructions to the device 302. For example, the interface 306 may be a keyboard, touch screen, and so forth. Other examples of interfaces are possible. The hearing instrument 308 may be a hearing aid in one example. The hearing instrument may be any type of hearing device (behind the ear, completely-in-the-canal, and so forth). The hearing instrument 308 is coupled to the processing device by any wired or wireless connection 311.

In one example of the operation of the system of FIG. 3, a patient 312 is presented with a audio sound via the speaker 310. The patient 312 is also presented with a visual representation of the sound at the visual display 304. A response to the audio sound and the visual representation is received from the patient 312 via the interface 306 and the response indicates a perception of what the sound is as perceived by the patient 312. Based upon the response from the patient, a first adjustment to the hearing instrument 308 is performed that is effective to adjust the sound. The audio sound is re-presented to the patient 312 with the adjusted sound. Subsequently, fine-tuning commands are received from the patient 312 via the interface 306 and the fine-tuning commands are effective to make a fine-tuning adjustment to the hearing instrument 308. In other aspects, after receiving each of the fine-tuning commands and making the fine-tuning adjustment to the hearing instrument 308 indicated by each of the fine-tuning commands, the audio signal is re-presented to the patient 312 with the fine-tuning adjustment. An Audiologist 314 and/or the patient 312 can make the determination that the patient has adequately perceived the sound indicating that the hearing instrument 308 is properly tuned. The Audiologist 314 may have a separate monitor 315 that is separate from the monitor viewed by the patient 312. The monitor 315 may indicate the tests in progress and the fitting/tuning solutions being implemented as the test proceeds. In addition, the Audiologist 314 may be able to alter the direction of the test, terminate aspects of the test, and perform other functions that alter the operation of the test.

In another example of the operation of the system of FIG. 3, the patient is presented with a first phoneme-rich audio sound. On a visual display, the patient is presented with first multiple visual options as to the identity of the first sound. This may be in the form of a multiple choice list of possible sounds. From the list, the patient chooses the sound they thought they heard. A first response from the patient to the multiple options and sound presented to them is received via a first interface and the first response indicates a first choice of the patient as to the identity of the first sound. Subsequently and based upon the response from the patient, an adjustment of the hearing instrument is performed, and the adjustment is effective to adjust the first sound. The first sound is re-presented to the patient with the adjustment. These steps are repeated until the response of the patient indicates an acceptable perception of the first sound has been made by the patient.

Then, the patient is presented with a second phoneme-rich audio sound and the second phoneme-rich sound is different from the first phoneme-rich sound. For instance, the first sound may be “aka” and the second sound may be “ama.” On the visual display, the patient is presented with second multiple visual options as to the identity of the second sound. From the second list, the patient chooses the sound they thought they heard. A second response to the multiple options and the second sound is received from the patient via the first interface and the second response indicates a second choice of the patient as to the identity of the second sound. Subsequently and based upon the second response from the patient, a second adjustment of the hearing instrument is performed and the second adjustment to the hearing instrument is effective to adjust at least one parameter of the hearing instrument and, consequently, the second sound. The second sound is re-presented to the patient with the second adjustment. These steps are repeated until the response of the patient indicates an acceptable perception of the second sound by the patient. In other aspects, a final adjustment of the hearing instrument is performed that incorporates the first adjustment and the second adjustment.

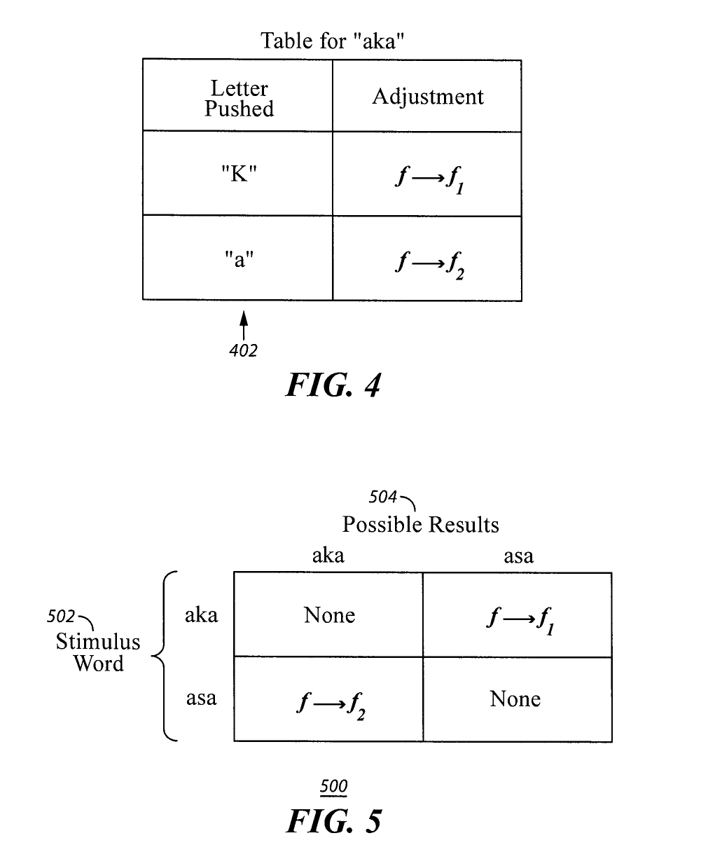

Referring now to FIG. 4, one example of a mapping approach, for example, using the approach of FIG. 1 is described. As described with respect to FIG. 1, the patient may press a key to indicate a sound they should have heard but did not hear (e.g., the patient presses the “k” key because they did not hear the “k” in “aka”). As shown in FIG. 4, a first column 402 indicates the letter pushed. A second column 404 indicates the adjustment that is mapped from the key press. For example, if “k” is pressed, the frequency is adjusted to f1. If “a” is pressed, the frequency is adjusted to f2.

It will be understood that for simplicity only two key presses are shown in FIG. 4 for the term “aka” and that these adjust one parameter of the hearing instrument. Other parameters may also be adjusted as well. Also, the adjustments in the table (e.g., the parameter to be adjusted and the magnitude of adjustment) may be determined in any number of ways such as from clinical trials. It will also be understood that the table 400 may be of any suitable data structure and stored on computer media or memory.

Referring now to FIG. 5, one example of a mapping approach, for example, using the approach of FIG. 2 is described. As described with respect to FIG. 2, the patient selects from a menu or list of choices the word they thought they heard. As shown in FIG. 5, this choice is mapped to a particular parameter change in the hearing instrument. A first side 502 of matrix 500 indicates stimulus word that was actually presented to the patient. A second side 504 indicates possible responses or choices made by patient and received. For example, if “aka” is actually presented, the patient may hear (in this example) “aka” or “asa” and choose accordingly. The matrix entries show the adjustment depending upon the actual word presented and the patient's response. For example, if “aka” is presented and “aka” is heard, no parameter is changed. If “aka” is presented and “aka” is heard, the frequency parameter of the hearing instrument is changed to f1.

It will be understood that for simplicity only two stimulus words and two possible responses are shown in FIG. 5 for the term “aka” and that these adjust one parameter. Other parameters may also be adjusted as well. Also, the adjustments (e.g., the parameter to adjust and the magnitude of adjustment) shown in the matrix 500 may be determined in any number of ways such as from clinical trials. It will also be understood that the matrix 500 may be of any suitable data structure and stored on computer media or memory.

It will be understood that many of the approaches described herein may be implemented as computer instructions stored on a computer memory or media and executed by a processor. It will be further appreciated that many of these approaches may also be implemented as combination of electronic hardware and/or software elements.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of tuning a hearing instrument, the method comprising:
presenting the patient with a phoneme-rich audio sound;
presenting the patient with a visual representation of the sound at a visual display;
receiving a response to the audio sound and the visual representation from the patient via a first interface, the response indicating a perception of sound from the patient;
based upon the response from the patient, performing a first adjustment to the hearing instrument that is effective to adjust the sound;
re-presenting the audio sound to the patient with the adjusted sound;
subsequently receiving fine-tuning commands from the patient via a second interface that fine-tuning commands effective to make a fine-tuning adjustment to the hearing instrument.

2. The method of claim 1 further comprising, after receiving each of the fine-tuning commands and making the fine-tuning adjustment to the hearing instrument indicated by each of the fine-tuning commands, re-presenting the audio signal to the patient with the fine-tuning adjustment.

3. The method of claim 1 wherein the visual display comprises a computer terminal.

4. The method of claim 1 wherein the first interface comprises a keyboard and the second interface comprises up and down arrows from a keyboard.

5. The method of claim 1 wherein the sending of fine-tuning commands is terminated by an audiologist.

6. The method of claim 1 further comprising, initializing the settings of the hearing instrument.

7. A method of tuning a hearing instrument, the method comprising:
(a) presenting the patient with a first phoneme-rich audio sound;
(b) on a visual display, presenting the patient with first multiple visual options as to the identity of the first sound;
(c) receiving a first response to the multiple options and sound from the patient via a first interface, the first response indicating a first choice of the patient as to the identity of the first sound;
(d) subsequently and based upon the response from the patient, performing an adjustment of the hearing instrument, the adjustment effective to adjust the first sound;
(e) re-presenting the sound to the patient with the adjustment;
(f) repeating steps (a)-(e) until the response of the patient indicates an acceptable perception of the first sound.

8. The method of claim 7 further comprising:
(g) presenting the patient with a second phoneme-rich audio sound, the second phoneme-rich sound being different from the first phoneme-rich sound;
(h) on the visual display, presenting the patient with second multiple visual options as to the identity of the second sound;
(i) receiving a second response to the multiple options and the second sound from the patient via the first interface, the second response indicating a second choice of the patient as to the identity of the second sound;
(j) subsequently and based upon the second response from the patient, performing a second adjustment of the hearing instrument, the second adjustment to the hearing instrument effective to adjust the second sound;
(k) re-presenting the second sound to the patient with the second adjustment;
(l) repeating steps (g)-(k) until the response of the patient indicates an acceptable perception of the second sound.

9. The method of claim 8 further comprising performing a final adjustment of the hearing instrument that incorporates the first adjustment and the second adjustment.

10. The method of claim 7 wherein the visual display comprises a computer terminal.

11. The method of claim 7 wherein the interface comprises a keyboard.

12. The method of claim 7 wherein the final adjustment is determined by an audiologist.

13. The method of claim 7 further comprising, initializing the settings of the hearing instrument.

14. A system for tuning a hearing instrument, the apparatus including:
a speaker, the speaker configured to presenting the patient with an audio sound;
a visual display, the visual display configured to present the patient with a visual representation of the sound;
an interface, the interface configured to receive a response to the audio sound and the visual representation from the patient, the response from the patient indicating a perception of the sound of the patient;
a controller coupled to the speaker, the visual display, and the interface, the controller configured to, based upon the response from the patient, send a first signal to the hearing instrument that adjusts at least one parameter of the hearing instrument and cause an adjustment of the sound, the controller further configured to cause the adjusted audio sound to be presented to the patient at the speaker, the controller further configured to subsequently receive fine-tuning commands from the patient via the interface, the fine-tuning commands effective to cause the controller to transmit a signal to the hearing instrument that makes a fine-tuning adjustment to the hearing instrument.

15. The system of claim 14 wherein the controller is configured to, after receiving each of the fine-tuning commands, and make the fine-tuning adjustment to the hearing instrument indicated by each of the fine-tuning commands, and the audio signal to be re-presented at the speaker to the patient with the fine-tuning adjustment.

16. The system of claim 14 wherein the visual display comprises a computer terminal.

17. The method of claim 14 wherein the interface comprises a keyboard.
